(19) United States
(12) Patent Application Publication
(10) Pub. No.: US 2010/0287574 A1
(43) Pub. Date: Nov. 11, 2010

(54) OPTICAL DISC REPRODUCING DEVICE AND METHOD OF EJECTION CONTROLLING OPTICAL DISC

(75) Inventor: Yusuke KUMAGAMI, Fukushima-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toshiba Alpine Automotive Technology Corporation, Iwaki-shi (JP)

(21) Appl. No.: 12/692,857

(22) Filed: Jan. 25, 2010

(30) Foreign Application Priority Data
May 7, 2009 (JP) 2009-112928

(51) Int. Cl. G11B 17/04

(52) U.S. Cl. 720/621; G9B/17.013

(57) ABSTRACT

An optical disc reproducing device including rollers configured to carry an optical disc inserted in a slot in an inside direction to a reproduction possible position and to carry the optical disc in an outside direction to a prescribed ejecting position from the reproduction possible position, a plurality of position detecting switches to detect positions of the optical disc in the device, and a carrying control unit configured to control to drive the rollers based on states of the position detecting switches so as to carry the optical disc. The carrying control unit, when the optical disc stops at a position except the reproduction possible position and the ejecting position, drives the rollers to carry the stopped optical disc to the ejecting position, in at least one of cases that a state of any position detecting switch has changed and that any operating key is operated by a user.

### CROSS-REFERENCE TO RELATED APPLICATIONS

This application is based upon and claims the benefit of priority from the prior Japanese Patent Application No. 2009-112928, filed on May 7, 2009; the entire contents of which are incorporated herein by reference.

### BACKGROUND OF THE INVENTION

1. Field of the Invention

This invention relates to an optical disc reproducing device to load and eject an optical disc in a slot in system and a method of ejection controlling an optical disc.

2. Description of the Background

A system of loading and ejecting an optical disc for an optical disc reproducing device is classified broadly into two systems. A first system is called as a tray system. In case of loading an optical disc, an optical disc is loaded in an empty tray pulled out from a device, and the optical disc is pushed into the device along with the tray. In case of ejecting the optical disc, the optical disc is pulled out from the device in the state that the optical disc is loaded in the tray.

A second system is called as a slot in system. In a device of a slot in system, a pair of rollers is provided inside a slot for an optical disc. In case of loading an optical disc in the device, the optical disc is nipped by a nip of the rollers and the optical disc is carried into the inside of the device by rotating the rollers. In case of ejecting the optical disc, the rollers are rotated in the reverse direction to carry out the optical disc to the outside of the device.

The slot in system has resistance to vibration and shock, because a tray to be pulled out to the outside is not required. Accordingly, the slot in system is widely used in an optical reproducing device for car use.

Refer to JP-A 2001-155401 (KOKAI) and so on.

In many optical disc reproducing devices of a slot in system, a plurality of switches to detect a position of an optical disc inside the device are provided in the device. To start or stop the rotation of the rollers is controlled not only by the operation of a loading button or an ejecting button provided in an operating panel of the device but also by the ON OFF states of the position detecting switches.

For example, when the position detecting switch detects that a front end of an optical disc is inserted in the slot of the device, the rollers start automatically rotating in the inserting direction, and the optical disc is drawn into the device even if a user does not purposely push the loading button. In addition, in case of ejecting the optical disc, a position of the optical disc in the state that a back end is still nipped by the rollers is detected by the position detecting switch so as to stop rotating the rollers. As a result, that the optical disc is separated completely from the rollers and drops on the floor and so on can be avoided.

By the way, in the optical disks used in the world, an optical disc (hereinafter, called as an abnormally-shaped disc) exists which can be reproduced by a device of a tray system but has a configuration unsuitable for a device of a slot in system or has a configuration not reproducible. In the abnormally-shaped disc, an optical disc with a special outer circumference configuration (for example, a star type configuration or a configuration featuring a popular character, and so on), an optical disc with a nonstandard configuration in thickness or an injured optical disc with one part vacant is included. In addition, for a device to reproduce only a standard optical disc with an external diameter of 12 centimeters, an optical disc with an external diameter of 8 centimeters is an abnormally-shaped disc.

The above-described position detecting switch is used to detect whether or not such an abnormally-shaped optical disc is inserted, but to detect all the abnormally-shaped optical disks by the position detecting switch is actually difficult. In addition, in case that an abnormally-shaped optical disc is inserted, the sequence of the ON OFF state of the position detecting switch may possibly be different from the sequence in case of the normal optical disc. So that the rollers may stop at an erroneous timing, and the optical disc may stop at a position except the normal stop position (hereinafter, called as an abnormal stop or a stack). Thus, the abnormally stopped optical disc remains in the device.

On the other hand, by the restriction of the construction and so on, the position detecting switch can not detect all the positions of the optical disc in the device, but a dead area inevitably exists where the position detection is not possible. In the dead area, all the position detecting switches are in the same state as the state where the optical disc is completely pulled out (for example, the state where all the position detecting switches are OFF). For this reason, when the optical disc abnormally stops in the dead area, the position detecting switch can not discriminate solely whether the optical disc abnormally stops in the device or the optical disc is completely pulled out from the device.

In case that a position where the optical disc stops abnormally is an inmost part of the device, that the optical disc remains in the device can not be visible from the outside. Thus, if the user inserts erroneously another optical disc in the device and the rollers are driven in the inserting direction, two optical disks are sent in the device, so that these disks may not be possibly taken out from the device.

Accordingly, conventionally, in order to avoid such a worst case, a safety side design was used that unless the user intentionally pushes down the ejecting button so as to eject the optical disc, other operation sequence (for example, to start rotating the rollers in the inserting direction) can not be operated.

But, in case that another user who does not know that the optical disc is in the abnormally stopped state in the device tries to insert another optical disc in the device, the another user does not probably think of an operation to push down the ejecting button. Accordingly, the another user may have dissatisfaction and distrust in that the rollers will not start rotating even if the optical disc is pushed into the slot.

In case that the optical disc stops in the state that one part of the optical disc is exposed outside, a user can pull out the optical disc from the device by hand. But, even in this case, the device is designed so that without pushing down the ejecting button the following sequence can not be operated. Accordingly, even if the optical disc is pushed into the slot, the rollers do not rotate. Therefore the user may have distrust in that any failure may have occurred.

JP-A 2001-155401 (KOKAI) discloses one example of the technique that the optical disc is loaded and ejected based on the state of the switch provided inside the device. But as for the action for the optical disc which has abnormally stopped in the device, nothing is disclosed.

### SUMMARY OF THE INVENTION

Accordingly, an optical disc reproducing device and a method of ejection controlling an optical disc are provided which can surely eject the optical disc outside the device without forcing an user extra operation and without inducing a secondary failure of the device in case that the optical disc stops abnormally inside the device.

According to an aspect of the present invention, there is provided an optical disc reproducing device, including rollers configured to carry an optical disc inserted in a slot in an inside direction of the device to a reproduction possible position and to carry the optical disc in an outside direction of the device to a prescribed ejecting position from the reproduction possible position, a plurality of position detecting switches to detect positions of the optical disc between an inlet port of the slot and the reproduction possible position, a carrying control unit configured to control to drive the rollers based on states of the position detecting switches so as to carry the optical disc. The carrying control unit, when the optical disc stops at a position except the reproduction possible position and the ejecting position, drives the rollers to carry the stopped optical disc to the ejecting position, in at least one of cases that a state of any position detecting switch out of the position detecting switches has changed and that any operating key out of a plurality of operating keys provided in the device is operated by a user regardless of the kind of the operating key.

According to another aspect of this invention, there is provided a method of ejection controlling an optical disc in a slot in system optical disc reproducing device including carrying an optical disc inserted in a slot in an inside direction of the device to a reproduction possible position by rollers and carrying the optical disc in an outside direction of the device to a prescribed ejecting position from the reproduction possible position by rollers, detecting positions of the optical disc between an inlet port of the slot and the reproduction possible position by a plurality of position detecting switches, and carry controlling to drive the rollers based on states of the position detecting switches so as to carry the optical disc. In carry controlling, when the optical disc stops at a position except the reproduction possible position and the ejecting position, in at least one of cases that a state of any position detecting switch out of the position detecting switches has changed and that any operating key out of a plurality of operating keys provided in the device is operated by a user regardless of a kind of the operating key, the rollers are driven to carry the stopped optical disc to the ejecting position.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view showing an example of an exterior appearance of an optical disc reproducing device according to an embodiment;

FIG. 2 is a block diagram showing an example of a construction of the optical disc reproducing device shown in FIG. 1;

FIG. 3 is a drawing showing an example of an arrangement of the position detecting switches and an example of a switch operating mechanism;

FIG. 4A through FIG. 4D are diagrams for explaining the change of the states of the position detecting switches and the driving control of the rollers when the optical disc is loaded;

FIG. 5 is a timing chart showing the change of the states of the position detecting switches and the driving control of the rollers in case of loading;

FIG. 6 is a timing chart showing the change of the states of the position detecting switches and the driving control of the rollers in case of ejecting;

FIG. 7 is a flow chart showing an example of processing according to an optical disc ejection control method of an embodiment;

FIG. 8A through FIG. 8D are drawings showing one example of the optical disc ejection processing according to a conventional method; and

FIG. 9A through FIG. 9D are drawings showing the optical disc ejection processing according to the embodiment in contrast to FIG. 8A through FIG. 8D.

### DETAILED DESCRIPTION OF THE INVENTION

Referring now to the drawings, wherein like reference numerals designate identical or corresponding parts throughout the several views, an optical disc reproducing device and a method of ejection controlling an optical disc according to an embodiment of the invention will be described below.

### (1) Construction

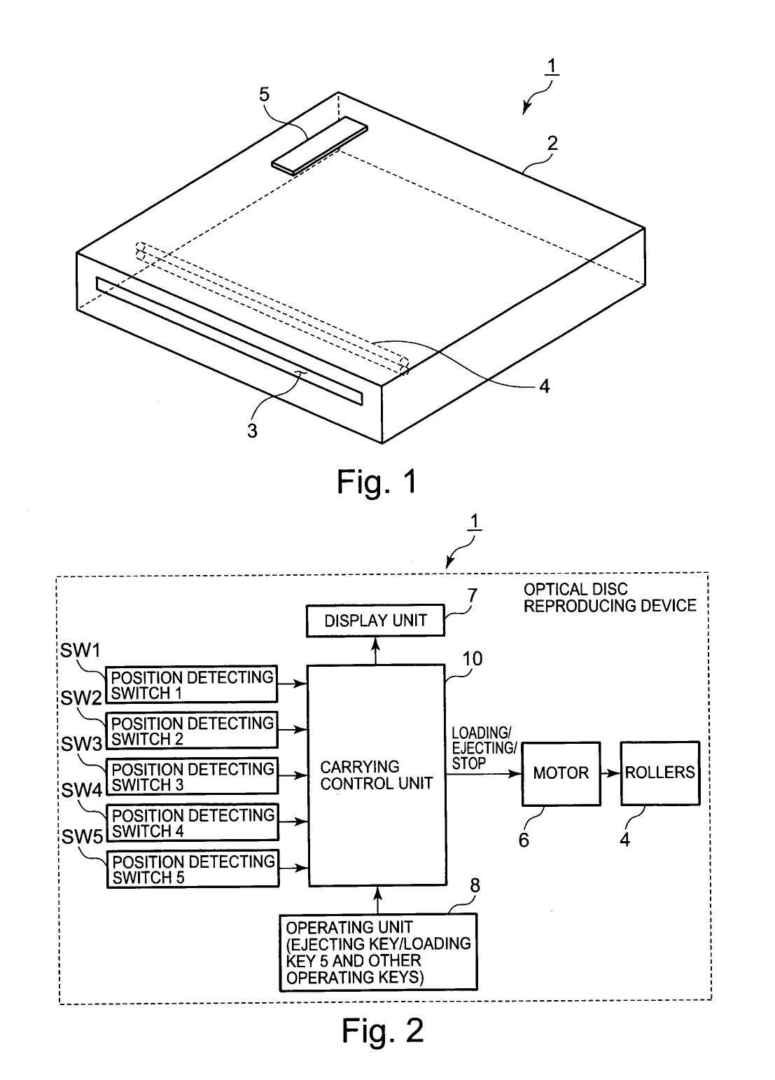

In FIG. 1, an optical disc reproducing device 1 is provided with a thin square shaped chassis 2, and at a front side of the chassis 2 a slot 3 is provided in which an optical disc is inserted. In addition, a pair of rollers 4 is provided at the slot 3 side of the inside of the chassis 2. When an optical disc is inserted in the optical disc reproducing device 1 from the slot 3, the rollers 4 are rotated and the optical disc is nipped by the nip of the rollers 4, and carried to a position where reproduction is possible (hereinafter called as a reproduction possible position) located near the center of the chassis 2.

At the upper portion of the chassis 2, an ejecting key/loading key 5 is provided so as to load or eject an optical disc in or from the device for a user by hand.

In addition, a display unit 7 (not shown) is connected to the optical disc reproducing device 1 by cable. The display unit 7 is capable of displaying the operation guide and the status of the optical disc reproducing device 1. The ejecting key/loading key 5 may be provided at the display unit 7 side.

FIG. 2 shows one example of the construction of the optical disc reproducing device 1 relating particularly to the loading and ejecting the optical disc.

The optical disc reproducing device 1 is provided with five position detecting switches SW1, SW2, SW3, SW4 and SW5 (in case of naming generally, called simply as a position detecting switch SW). In addition, the optical disc reproducing device 1 is provided with a carrying control unit 10, a motor 6, the rollers 4, an operating unit 8 and the display unit 7 and so on.

The operating unit 8 is provided with various operating keys for the optical disc reproducing device 1, such as a reproducing key, a fast-forward key and a quick return key. As described above, the operating unit 8 and the display unit 7 may be constructed separately from the chassis 2 of the optical disc reproducing device 1.

The position detecting switches SW detect the positions of the optical disc inserted in the device from the slot 3. Each of the switches SW can take two states of ON and OFF.

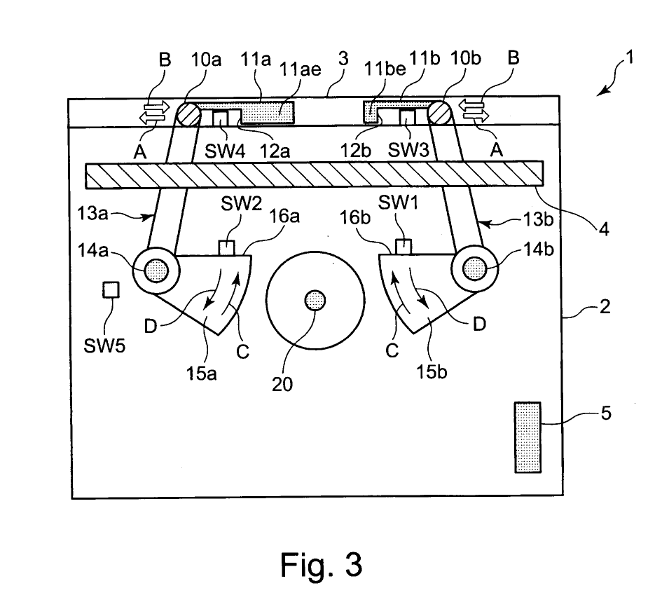

The rollers 4 nip the optical disc inserted in the slot 3 by the nip and carry the optical disc in the internal direction of the device to the reproduction possible position. That is, the rollers 4 carry the optical disc in the internal direction so that a central hole of the optical disc coincides with a position of an axis 20 (refer to FIG. 3) of rotation of the optical disc at the central portion of the device. On the other hand, in case of ejecting the optical disc, the rollers 4 rotate in the reverse direction from the direction in loading, and carry the optical disc in the external direction of the optical disc reproducing device 1 from the reproduction possible position to a prescribed ejecting position.

The rollers 4 are driven by the motor 6. The rotation control (the direction of the rotation, start and stop of the rotation) of the motor 6 is performed by the carrying control unit 10. The carrying control unit 10 controls to carry the optical disc (loading and ejection) by controlling the rotation of the motor 6 based on the ON and OFF states of the position detecting switches SW.

FIG. 3 shows schematically an arrangement of the five position detecting switches SW and the switch operating mechanism to make the position detecting switches SW ON and OFF. In FIG. 3, the upper side is a position where the slot 3 is arranged. Here, FIG. 3 shows the state of the device in a condition where an optical disc is not loaded in the device.

The position detecting switches SW1, SW2, SW3, SW4 and SW5 are arranged at the positions as shown in FIG. 3. In addition, the switch operating mechanism is provided with contact members 10a, 10b, sliding members 11a, 11b and levers 13a, 13b and so on.

At the entrance of the slot 3, the two cylindrical contact members 10a, 10b are arranged separately with a distance smaller than an external diameter of the optical disc. The sliding members 11a, 11b are jointed to the contact members 10a, 10b, respectively.

Here, a gap between a notch tip 12a of the sliding member 11a and the position detecting switch SW4 is smaller than a gap between a notch tip 12b of the sliding member 11b and the position detecting switch SW3. In addition, a width of an end portion 11ae of the sliding member 11a is larger than a width of an end portion 11be of the sliding member 11b.

When a tip of the optical disc is inserted into the slot 3, the two points at the outer circumference of the optical disc firstly contact the contact members 10a, 10b, respectively. When the optical disc moves further into the inmost side, the contact members 10a, 10b move in the directions of arrows A to open out further, respectively. Interlocked with the opening out of the contact members 10a, 10b, the sliding member 11a, 11b move in the direction of arrows A to open out further, respectively. The sliding members 11a, 11b are biased by springs for example, and open out against the biased power in the directions of the arrows A, respectively.

One end portions of the levers 13a, 13b are jointed to the contact members 10a, 10b, respectively. At the other end portions of the levers 13a, 13b, fan-like pressing members 15a, 15b are provided, respectively. The central portions of the levers 13a, 13b at the other end portions are fixed to the axis 14a, 14b so as to rotate freely, respectively. When the contact members 10a, 10b move in the directions of the arrows A, fan-like pressing members 15a, 15b rotate in the directions of arrows C, respectively, interlocked with the movements of the contact members 10a, 10b.

When the optical disc moves into the inner side of the device, the contact members 10a, 10b move to open out gradually. And when the optical disc reaches a position where the central portion of the optical disc and the contact members 10a, 10b are in a straight line, the contact members 10a, 10b open out at maximum. Then, when the optical disc moves further into the inmost side of the device, the contact members 10a, 10b move to close in the directions of arrows B inversely while moving along the outer circumference of the optical disc.

Interlocked with the closing movements of the contact members 10a, 10b, the sliding members 13a, 13b move to close in the directions of the arrows B, respectively. In addition, the pressing members 15a, 15b of the levers 13a, 13b move back in the directions of arrows D, respectively.

When the optical disc is moved to the reproduction possible position, the contact members 10a, 10b, the sliding members 11a, 11b and the levers 13a, 13b return to the positions at a time before the optical disc is inserted into the slot 3.

### (2) Fundamental Operation of Loading and Ejecting an Optical Disc

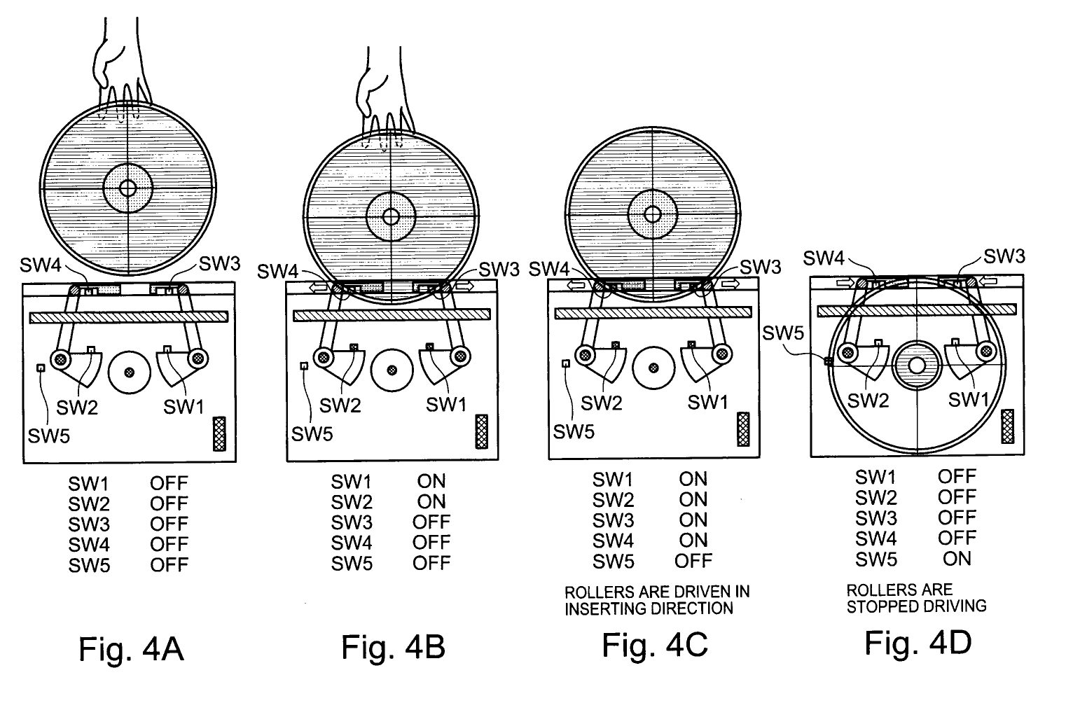

Here, FIG. 4A through FIG. 4D show mainly position of the optical disc and the change of the states of the position detecting switches SW1-SW5, so that the positions of the sliding members 10a, 10b, the levers 13a, 13b and the pressing members 15a, 15b are shown in the states that they are not moved nor rotated.

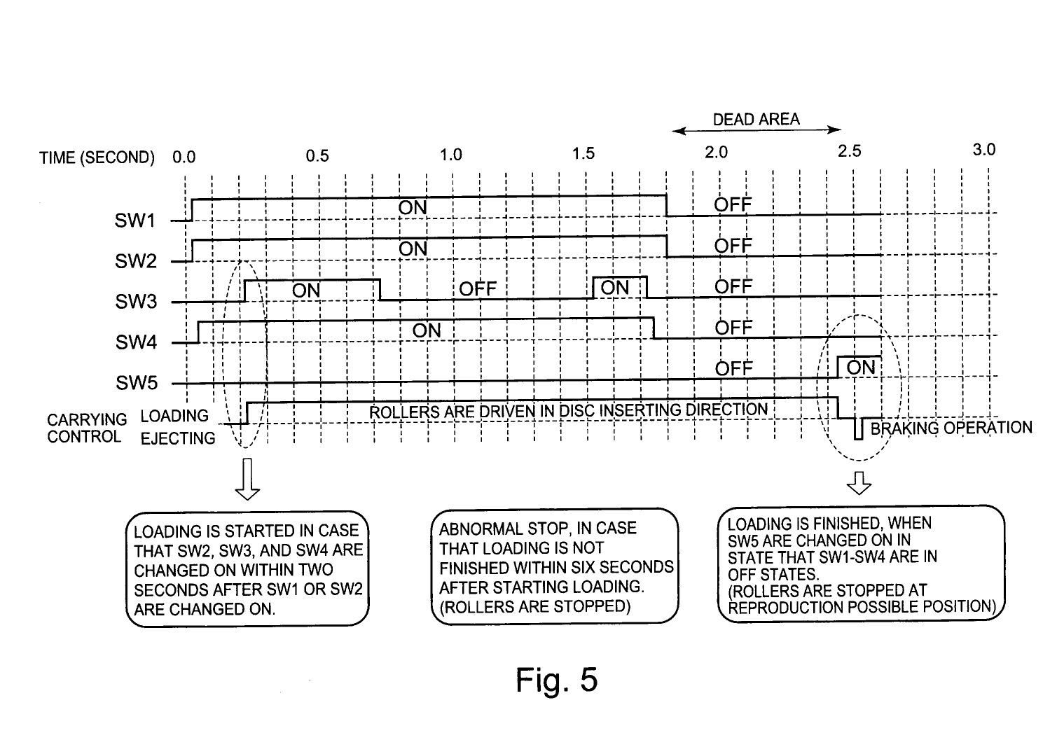

FIG. 4A shows the state before the optical disc is loaded. The position detecting switches SW1-SW5 are all in the OFF states. This state is shown in FIG. 5 at a time period of 0.0 second.

When a user inserts an optical disc in the slot 3, the contact members 10a, 10b move in the direction of the outer sides to open out, and tip portions 16a, 16b of the pressing members 15a, 15b of the levers 13a, 13b contact firstly the position detecting switches SW1, SW2, respectively. In this time, the position detecting switches SW1, SW2 changes respectively from the OFF states to the ON states at the approximately same timing. FIG. 4B shows this state. This state is shown in FIG. 5 at a time period of about 0.1 second.

When the optical disc is inserted a little further in the inmost direction, the contact members 10a, 10b move further in the outer direction to open out, the notch tip 12a of the sliding member 11a at the left side shown in FIG. 3 contacts the position detecting switch SW4, and the position detecting switch SW4 changes from the OFF state to the ON state.

When the optical disc is inserted a little more further in the inner direction, the contact members 10a, 10b move more further in the outer direction to open out, the notch tip 12b of the sliding member 11b at the right side shown in FIG. 3 contacts the position detecting switch SW3, and the position detecting switch SW3 changes from the OFF state to the ON state.

The carrying control unit 10 monitors the state of each of the position detecting switches SW. When all the three position detecting switches SW2, SW3 and SW4 change to the ON states within two seconds after the position detecting switch SW1 or SW2 is changed from OFF to ON, the carrying control unit 10 starts rotating the rollers 4. Accordingly, usually at a time period when the position detecting switch SW3 changes from OFF to ON, the rollers 4 starts rotating the optical disc to carry the optical disc in the inside direction of the device. FIG. 4C shows this state. This state is shown in FIG. 5 at a time period of about 0.3 second.

As the optical disc is carried to the inmost side of the device, the contact members 10a, 10b move out separately to open to the maximum width. During this time, the end portion 11be of the sliding member 11b moves in the right direction. As the width of the end portion 11be is small, the end potion 11be pass through the position of the position detecting switch SW3, so that the position detecting switch SW3 changes the state from OFF to ON and then ON to OFF. Then the optical disc is further inserted inside the device, the sliding members 11a and 11b move in the closing direction. During this time, the sliding member 11b moves in the left direction, so that the position detecting switch SW3 changes from OFF to ON. When the optical disc moves near the reproduction possible position, the position detecting switches SW1, SW2, SW3 and SW4 then change from ON to OFF, and all the five position detecting switches SW1, SW2, SW3, SW4 and SW5 become in the OFF states.

Then, when the optical disc is carried to the reproduction possible position, the outer circumference of the optical disc contact the position detecting switch SW5 as shown in FIG. 4D, and the position detecting switch changes from OFF to ON. This state is shown in FIG. 5 at a time period of about 2.6 seconds.

The carrying control unit 10 judges that the loading is finished when the position detecting switch SW5 changes from OFF to ON in the state that all the four position detecting switches SW1, SW2, SW3 and SW4 are in the OFF states, and stops rotating the rollers 4.

In addition, from a position where all the four position detecting switches SW1, SW2, SW3 and SW4 change to the OFF states, to a position where the position detecting switches SW5 changes from OFF to ON, all the position detecting switches SW are in the OFF states. Accordingly, this area is, so to speak, a dead area, because a state that an optical disc exists normally in this area can not be discriminated from a state that the optical disc does not exist in the device, only from the states of the position detecting switches SW.

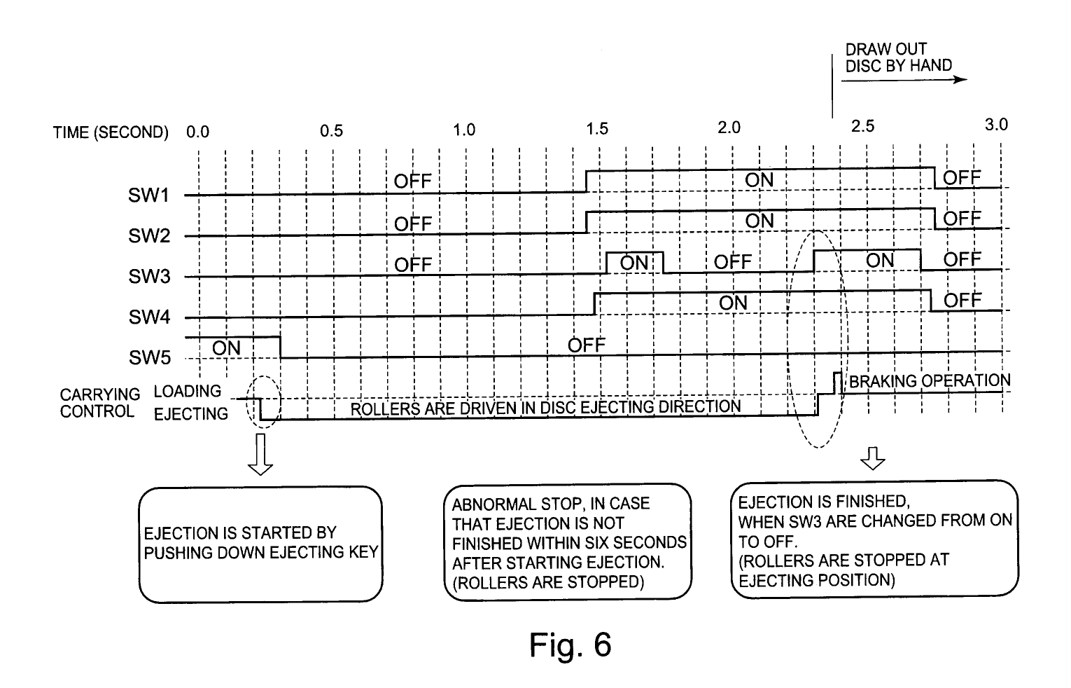

In the optical disc reproducing device 1 according to the embodiment, the processing of ejecting the optical disc can be performed by an operation too, except the operation of the ejecting key as described below. But, a timing chart of the ejecting operation of the optical disc by the operation of the ejecting key is shown in FIG. 6 as a standard operation.

When the optical disc stops at the reproduction possible position (normal stop position), only the position detecting switch SW5 is in the ON state and all the other position detecting switches SW1-SW4 are in the OFF states.

When the ejecting key is pushed down, the carrying control unit 10 starts the ejecting operation so as to rotate the rollers 4 in the ejecting direction. When the optical disc is carried in the direction of the slot 3, the position detecting switches SW change the states in the inverse direction of the direction in the loading sequence shown in FIG. 5. Here, the position detecting switch SW3 changes the state as OFF, ON, OFF, ON and OFF.

The carrying control unit 10 judges that the ejection is finished at a timing when the position detecting switch SW3 changes from OFF to ON in the second time and all the four position detecting switches SW1-SW4 become in the ON states, and stops rotating the rollers 4. This state is the same state as shown in FIG. 4C, and the optical disc stops in the state that one part of the optical disc is nipped by the rollers 4. This stop position is called as an ejecting position. Therefore, the optical disc does not fall on the floor and so on by jumping out from the slot 3. In addition, as the greater part of the optical disc is exposed outside from the slot 3, the user can easily pull out the optical disc.

When the user takes out the optical disc to the outside, the position detecting switches SW1-SW4 changes ON to OFF, and all the position detecting switches SW become in the OFF states.

### (3) Ejection Control Method.

The timing sequences shown in FIG. 5 and FIG. 6 show the normal loading control and ejection control in the normal state usually used.

However, in case that an abnormally-shaped disc and so on is inserted in the optical disc reproducing device 1, the position detecting switches SW do not necessarily change the states as shown in FIG. 5 and FIG. 6. But the optical disc may stop at a position except the reproduction possible position (abnormal stop).

In case that the loading is not finished within a prescribed time (for example, within 6 seconds) after starting the loading (the position detecting switch SW5 changes from OFF to ON in the state that the position detecting switches SW1-SW4 are in the OFF states), as the abnormally-shaped optical disc and so on may be possibly inserted, the carrying control unit 10 is so designed as to stop the rollers 4. This case is an abnormal stop in loading.

In addition, in case that the ejection is not finished within a prescribed time (for example, within 6 seconds) after starting the ejection (the position detecting switch SW3 changes from OFF to ON), the carrying control unit 10 is so designed as to stop the rollers 4. This case is an abnormal stop in ejecting.

According to the embodiment, when the optical disc is in the abnormal stop state inside the device, the carrying control unit 10 usually monitors the change in the states of the position detecting switches SW1-SW5, and when at least one of the five position detecting switches SW1-SW5 changes the state, both in case of the change from ON to OFF and the change from OFF to ON, the optical disc reproducing device 1 is designed to drive the rollers 4 so that the optical disc is carried to the ejecting position.

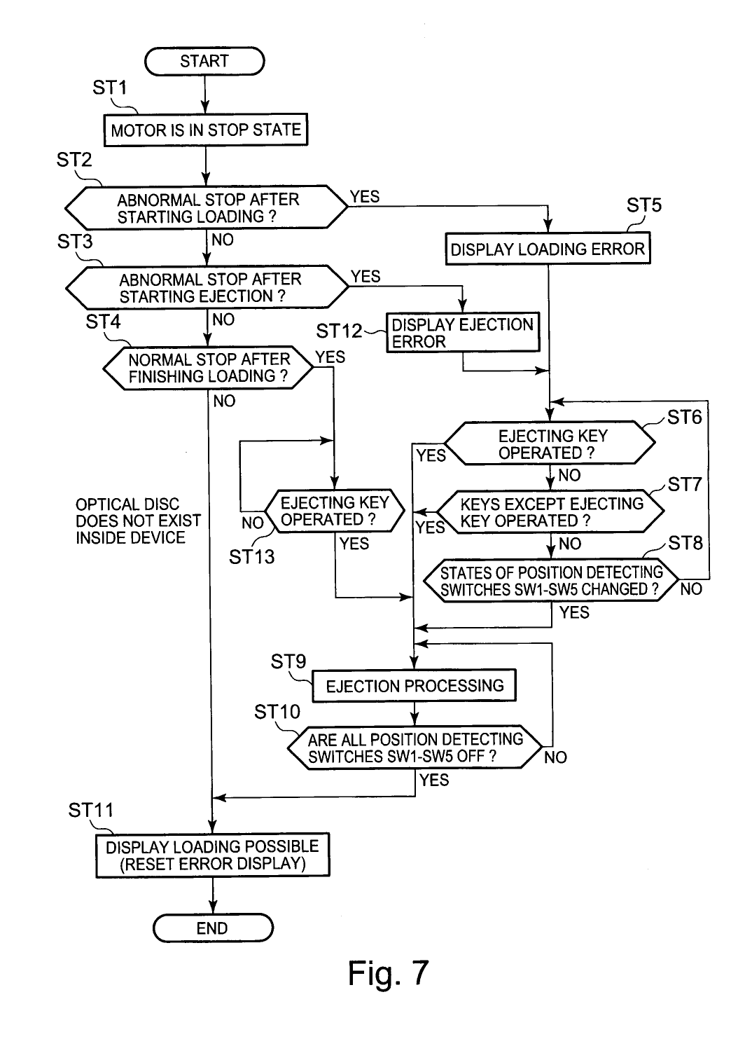

Hereinafter, an optical disc ejection control method according to an embodiment will be described in detail with reference to FIG. 7. The method shown in the flow chart in FIG. 1 is performed by the carrying control unit 10. Here, the carrying control unit 10 may be composed of a computer, for example.

In FIG. 7, whether or not an optical disc is in the stop state inside the device is judged in steps ST1, ST2, ST3, ST4, and in case that the optical disc is in the stop state, in what state the optical disc stops is judged.

In case that the optical disc is in the stop state, the motor 6 to drive the rollers 4 is to be in the stop state, which is confirmed by the step ST1.

The step ST2 judges whether or not the stop is an abnormal stop in loading. The step ST3 judges whether or not the stop is an abnormal stop in ejecting. The step ST4 judges whether or not the stop is a normal stop after the loading is finished.

In case that the motor 6 is in the stop state, and except in case of the abnormal stop in loading, the abnormal stop in ejecting and the normal stop (NO in all the steps ST2, ST3, ST4), this case means that the optical disc does not exist inside the device. In this case, the processing goes to a step ST11.

On the other hand, in case of the abnormal stop in loading (YES in the step ST2), a loading error display is performed in a step ST5.

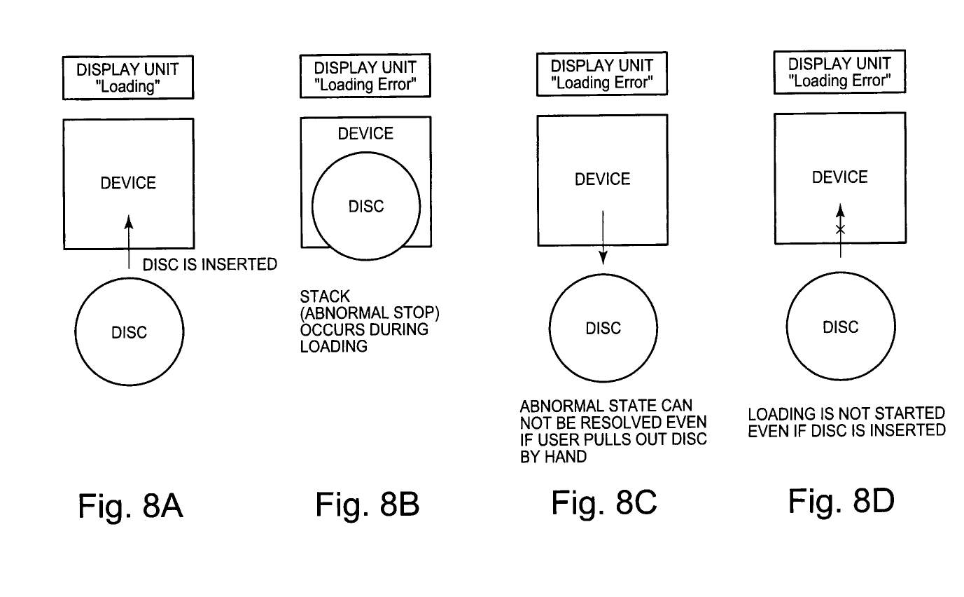

As described above, conventionally an optical disc reproducing device was designed such that in case of the abnormal stop, unless the user operates the ejecting key, the abnormal stop state can not be reset, and the loading operation is not performed. (above-described safety side design). FIG. 8A through FIG. 8D describe an example of the inconvenience caused based on such the conventional design.

When the optical disc is inserted in the device, the rollers 4 rotate, and a display indicating that the device is in loading, for example, “Loading”, is displayed on the display unit 7. (FIG. 8A)

In case that the inserted optical disc is an abnormally-shaped disc and so on, the abnormal stop occurs in loading. In this case, a display indicating the abnormal stop in loading, for example “Loading Error” is displayed on the display unit 7. (FIG. 8B) Conventionally, even if the user pulls out the optical disc from the device by hand, the abnormal state can not be resolved, and the display “Loading Error” is remained. (FIG. 8C) In addition, even if the user then inserts the optical disc in the device, the loading processing is not performed. If the user pushes down the ejecting key, the abnormal state can be resolved and the loading processing can be performed. But, in many cases, the user can not conceive an operation to push down the ejecting key, resulting that the user may be dissatisfied and distrust for the device.

Compared with this, in a method of ejection controlling the optical disc according to the embodiment, after the loading error is displayed in the step ST5, the processing goes to steps ST6, ST7, ST8.

The steps ST6-ST8 monitors as follows. The step ST6 monitors the presence or absence of an operation to the ejecting key (for example, the ejecting key is pushed down). The step ST7 monitors the presence or absence of an operation to an operating key except the ejecting key (for example, the loading key is pushed down, or the reproducing key or the fast-forward key is operated). The step ST8 monitors the changes of the ON OFF states of the position detecting switches SW1-SW5. In case that the ejecting key is operated (YES in the step ST6), the processing to eject the optical disc (the processing to rotate the rollers 4 in the ejecting direction to stop the optical disc at the prescribed ejecting position) is performed, and the device ejects the optical disc stopped abnormally in a step ST9. In addition, in case that the operating key except the ejecting key is pushed down (YES in the step ST7), the device ejects the optical disc stopped abnormally in the step ST9.

In addition, in case that any of the position detecting switch SW out of the position detecting switches SW1-SW5 changes the state (YES in the step ST8), the processing of ejecting the optical disc is performed in the step ST9. In case that the user tries to pull out the optical disc stopped abnormally or tries to push the optical disc into the inside of the device, any of the position detecting switch SW out of the position detecting switches SW1-SW5 changes the state. In such cases, the processing to eject the optical disc is also performed in the step ST9.

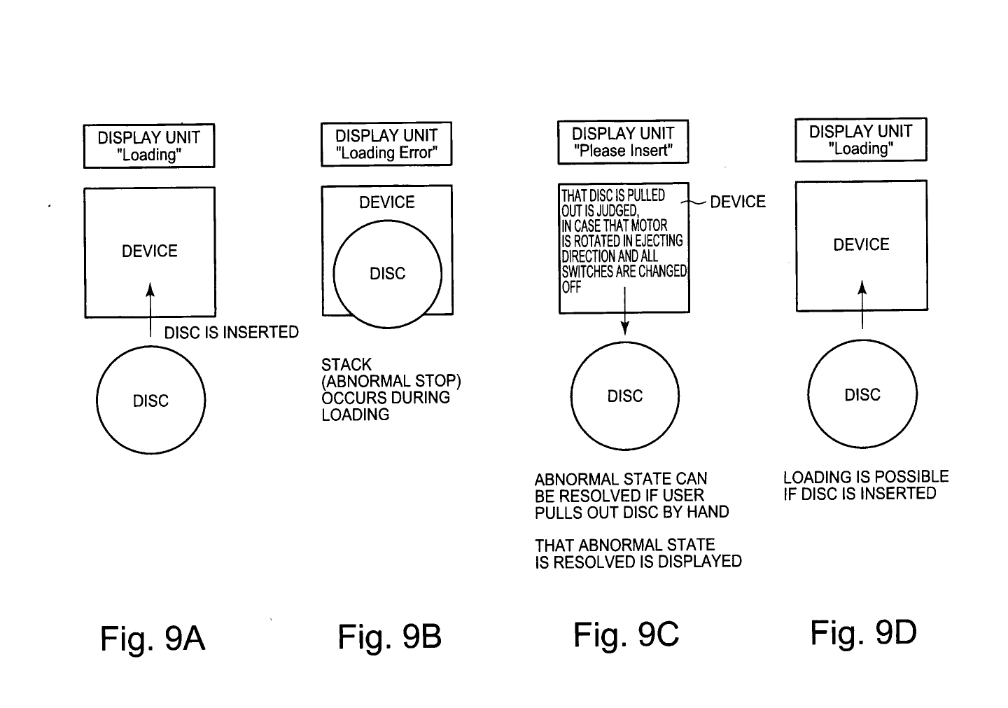

In FIG. 9A-FIG. 9D, the processing in FIG. 9A and FIG. 9B is the same as in FIG. 8A and FIG. 8B. In the embodiment, the states of the position detecting switches SW are monitored in the step ST8. When the user moves the optical disc in the front side direction so as to take out the optical disc in the abnormal stop state, as any of the position detecting switch SW out of the position detecting switches SW1-SW5 inevitably changes the ON OFF state, the processing to eject forcibly the optical disc is performed, and the rollers 4 are rotated so as to stop the optical disc at the ejecting position. (the steps ST8, ST9). Then, the user pulls out the optical disc from the ejecting position completely, and the states of all the position detecting switches SW1-SW5 become OFF. (YES in a step ST10).

Then, the abnormal state is reset in the step ST11. That is, the display “Loading Error” is deleted, at the same time the loading operation is made possible and the display indicating that effect, for example, “Please Insert” and so on is displayed. (FIG. 9C)

The user inserts the optical disc according to the display, and new loading processing will be started. (FIG. 9D)

In case that an abnormal stop occurs in ejecting, (YES in the step ST3), the display differs in that the content of the error display is, for example, “Ejection Error” (in a step ST12), and the other processing is the same as described above in the steps ST6-ST8.

When the optical disc is in the abnormal stop state at a position not visible for the user from the outside, the user may erroneously further insert another optical disc in the slot 3. In this case, a double insertion is caused, and the worst case that the two optical disks can not be pulled out from the device may occur. In the optical disc reproducing device according to the embodiment, when another disc is inserted further in the slot 3, as the state of any of the position detecting switches SW1-SW4 (particularly the switches SW1 and SW2), changes from OFF to ON, the rollers 4 are started rotating in the ejecting direction. As a result, to insert a new disc can be prevented, and in addition, the optical disc in the abnormal stop state inside the device can be automatically ejected.

In case that the optical disc is at the reproduction possible position (normal position) (YES in the step ST4), an operation of the ejecting key is monitored in a step ST13. When the ejecting key is operated, the optical disc is carried to the ejecting position in the step ST9. The processing after the step ST9 is the same processing as described above.

As described above, in the optical disc reproducing device 1 and the method of ejection controlling the optical disc, when the optical disc stops abnormally in the device (that is, stops at the position except the reproduction possible position and the ejecting position), in case that a state of any position detecting switch out of a plurality of position detecting switches changes, or in case that any operating key out of a plurality of operating keys provided in the device is operated regardless of the kind of the operating key, the device is designed so that the rollers 4 are driven to carry the optical disc in the stop state to the ejecting position.

As a result, in case that the optical disc stops abnormally in the device,

a) the device can be returned to the normal state from the abnormal state only as the user pulls out the optical disc,
b) the optical disc is ejected and the device can be returned to the normal state from the abnormal state, even if inversely the user pushes the optical disc into the device, and
c) the optical disc is ejected and the device can be returned to the normal state from the abnormal state not only by pushing down the ejecting key, but by pushing down the loading key or by operating the other operating keys. In addition, in such a case that the optical disc stops abnormally in the state that the optical disc is not exposed outside from the slot, the user may try to pick up the optical disc located inside by pushing a finger or a pair of tweezers and so on into the device from the slot 3. But in the optical disc reproducing device 1 according to the embodiment, when the state of the position detecting switch SW changes by the movement of the finger or a pair of tweezers and so on, the optical disc can be ejected forcibly, so that a case that the device may be damaged by receiving extra strain by the finger or a pair of tweezers and so on can be avoided.

In addition, as described above, the double insertion of the optical disks can be prevented, and the optical disc remained inside the device can be ejected by inserting a second optical disc.

In the above-described embodiment, the carrying control unit 10 performs the control operation in the order of the steps ST6, ST7 and ST8 as shown in FIG. 7. But, this invention is not limited to this embodiment. The order of the steps may be changed as the steps ST7, ST6 and ST8, for example.

Obviously, numerous modifications and variations of the present invention are possible in light of the above teachings. It is therefore to be understood that within the scope of the appended claims, the invention may be practiced otherwise than as specifically described herein.

What is claimed is:

1. An optical disc reproducing device, comprising:
rollers configured to carry an optical disc inserted in a slot in an inside direction of the device to a reproduction possible position and to carry the optical disc in an outside direction of the device to a prescribed ejecting position from the reproduction possible position;
a plurality of position detecting switches to detect positions of the optical disc between an inlet port of the slot and the reproduction possible position; and
a carrying control unit configured to control to drive the rollers based on states of the position detecting switches so as to carry the optical disc;
the carrying control unit, when the optical disc stops at a position except the reproduction possible position and the ejecting position, driving the rollers to carry the stopped optical disc to the ejecting position, in at least one of cases that a state of any position detecting switch out of the position detecting switches has changed and that any operating key out of a plurality of operating keys provided in the device is operated by a user regardless of the kind of the operating key.

2. The device according to claim 1, wherein:
the carrying control unit drives the rollers to carry the optical disc in the inside direction of the device, when the optical disc does not remain inside the device, and in case that a loading key to load the optical disc in the device is operated; and
the carrying control unit drives the rollers to carry the stopped optical disc to the ejecting position, when the optical disc stops at the position except the reproduction possible position and the ejecting position, and in case that the loading key out of the operating keys is operated.

3. The device according to claim 1, wherein:
the carrying control unit drives the rollers to carry the optical disc to the ejecting position, when the optical disc stops at the position except the reproduction possible position and the ejecting position, and in at least one of cases that a state of any position detecting switch out of the position detecting switches changes by an action that the stopped optical disc is pushed into the device and that a state of any position detecting switch out of the position detecting switches changes by an action that the stopped optical disc is drawn out from the device.

4. The device according to claim 1, wherein:
when the optical disc stops at the position except the reproduction possible position and the ejecting position, in case that a state of any position detecting switch out of the position detecting switches changes by an action that a different optical disc from the stopped optical disc is pushed into the slot, the carrying control unit rotates the rollers in the ejecting direction to push back the different pushed in optical disc and drives the rollers to carry the stopped optical disc to the ejecting position.

5. A reproducing device having a slot for an optical disc with a plurality of operating keys, comprising:
rollers configured to carry an optical disc inserted in an inlet port of the slot to a reproduction possible position and to carry the optical disc to the inlet port from the reproduction possible position;
a plurality of position detecting switches to detect positions of the optical disc between the inlet port of the slot and the reproduction possible position; and
a carrying control unit configured to control to drive the rollers based on states of the position detecting switches so as to carry the optical disc;
the carrying control unit including,
a first control unit configured to detect whether the optical disc has stopped abnormally between the inlet port of the slot and the reproduction possible position,
a second control unit configured to detect whether any operating key other than an ejecting key among the operating keys is operated by a user, after the optical disc has abnormally stopped, and
a third control unit configured to driving the rollers so as to carry the optical disc abnormally stopped to the inlet port of the slot in response to the any operating key other than the ejecting key.

6. A method of ejection controlling an optical disc in an optical disc reproducing device, comprising:
carrying an optical disc inserted in a slot in an inside direction of the device to a reproduction possible position by rollers and carrying the optical disc in an outside direction of the device to a prescribed ejecting position from the reproduction possible position by rollers;
detecting positions of the optical disc between an inlet port of the slot and the reproduction possible position by a plurality of position detecting switches; and
carry controlling to drive the rollers based on states of the position detecting switches so as to carry the optical disc;
in the carry controlling, when the optical disc stops at a position except the reproduction possible position and the ejecting position, in at least one of cases that a state of any position detecting switch out of the position detecting switches has changed and that any operating key out of a plurality of operating keys provided in the device is operated by a user regardless of a kind of the operating key, driving the rollers to carry the stopped optical disc to the ejecting position.

7. The method according to claim 6, wherein:
in the carry controlling, driving the rollers to carry the optical disc in the inside direction of the device, when the optical disc does not remain inside the device, and in case that a loading key to load the optical disc in the device is operated; and
in the carry controlling, driving the rollers to carry the stopped optical disc to the ejecting position, when the optical disc stops at the position except the reproduction possible position and the ejecting position, and in case that the loading key out of the operating keys is operated.

8. The method according to claim 6, wherein:
in the carry controlling, driving the rollers to carry the optical disc to the ejecting position, when the optical disc stops at the position except the reproduction possible position and the ejecting position, and in at least one of cases that a state of any position detecting switch out of the position detecting switches changes by an action that the stopped optical disc is pushed into the device and that a state of any position detecting switch out of the position detecting switches changes by an action that the stopped optical disc is drawn out from the device.

9. The method according to claim 6, wherein:
when the optical disc stops at the position except the reproduction possible position and the ejecting position, in case that a state of any position detecting switch out of the position detecting switches changes by an action that a different optical disc from the stopped optical disc is pushed into the slot, the carry controlling rotating the rollers in the ejecting direction to push back the different pushed in optical disc and drives the rollers to carry the stopped optical disc to the ejecting position.
